(19) United States
(12) Patent Application Publication
(10) Pub. No.: US 2024/0291041 A1
(43) Pub. Date: Aug. 29, 2024

(54) LITHIUM SECONDARY BATTERY

(71) Applicant: NGK INSULATORS, LTD., Nagoya-City (JP)

(72) Inventors: Kengo OISHI, Nagoya-City (JP); Shigeki OKADA, Nagoya-City (JP); Ken SHIMAOKA, Nagoya-City (JP)

(73) Assignee: NGK INSULATORS, LTD., Nagoya-City (JP)

(21) Appl. No.: 18/632,396

(22) Filed: Apr. 11, 2024

Related U.S. Application Data
(63) Continuation of application No. PCT/JP2022/038073, filed on Oct. 12, 2022.

(30) Foreign Application Priority Data
Oct. 15, 2021 (JP) 2021-169596

(51) Int. Cl. H01M 10/0585; H01M 10/052; H01M 50/109; H01M 50/531

(52) U.S. Cl. CPC H01M 10/0585; H01M 10/052; H01M 50/109; H01M 50/531

(57) ABSTRACT

A lithium secondary battery including a plurality of positive electrode layers, negative electrode layers, and separators, and in which the positive electrode layers and the negative electrode layers are alternately laminated through the separators. The laminate includes a first insulating layer contacting a first end portion of each of the positive electrode layers in a width direction thereof, and a second insulating layer contacting a second end portion of each of the negative electrode layers in a width direction thereof on a side opposite to the first end portion in the width direction. When an external width of the laminate is represented by W, and an average of widths of the first insulating layers and widths of the second insulating layers is represented by wₐᵥₑ, a ratio “(wₐᵥₑ/W)×100” falls within a range of from 0.8 (%) to 40 (%).

### TECHNICAL FIELD

The present disclosure relates to a lithium secondary battery. This application claims priority from Japanese Patent Application No. 2021-169596, filed on Oct. 15, 2021, the contents of which are incorporated herein by reference in their entirety.

### BACKGROUND ART

There has been known a lithium secondary battery including: a positive electrode layer including a sintered body of a lithium composite oxide; a negative electrode layer including a titanium-containing sintered body; and a ceramic separator arranged between the positive electrode layer and the negative electrode layer. In Patent Literature 1, for example, there is a disclosure of a lithium secondary battery including an integrated sintered plate in which a positive electrode layer, a ceramic separator, and a negative electrode layer are bonded to each other, the battery being impregnated with an electrolytic solution. The separator of the lithium secondary battery disclosed in Patent Literature 1 is a ceramic separator including MgO and glass.

In Patent Literature 2, there is a disclosure of an all-solid-state battery including a laminate in which a plurality of positive electrode layers and a plurality of negative electrode layers are alternately laminated through a solid electrolyte layer. In the laminate disclosed in Patent Literature 2, a side margin layer is arranged on the outer peripheral side of each of the positive electrode layers and the negative electrode layers so as to be arranged side by side therewith. The side margin layer includes the same material as that of the solid electrolyte layer.

### CITATION LIST

### Patent Literature

[PTL 1] WO 2019/221144 A1
[PTL 2] JP 2021-27044 A

### SUMMARY OF INVENTION

### Technical Problem

Along with the development of equipment using a lithium secondary battery, a lithium secondary battery having a large discharge capacity even when discharge is performed at a large current and a high speed has been desired.

In view of the foregoing, an object of the invention according to the present disclosure is to provide a lithium secondary battery having a large discharge capacity and a high rate characteristic even when discharge is performed at a large current and a high speed.

### Solution to Problem

According to an embodiment of the present disclosure, there is provided a lithium secondary battery, including a laminate, which includes a plurality of positive electrode layers, a plurality of negative electrode layers, and a plurality of separators, and in which the positive electrode layers and the negative electrode layers are alternately laminated through the separators. The laminate includes a first insulating layer and a second insulating layer. The first insulating layer is arranged in a first end portion of each of the positive electrode layers in a width direction thereof so as to be brought into contact with the positive electrode layer. The second insulating layer is arranged in a second end portion of each of the negative electrode layers in a width direction thereof, the second end portion being positioned on a side opposite to the first end portion in the width direction, so as to be brought into contact with the negative electrode layer. When an external width of the laminate is represented by W, and an average of widths of the first insulating layers and widths of the second insulating layers is represented by wₐᵥₑ, a ratio “(wₐᵥₑ/W)×100” falls within a range of from 0.8 (%) to 40 (%).

### Advantageous Effects of Invention

The lithium secondary battery of the present disclosure can provide a lithium secondary battery having a large discharge capacity and a high rate characteristic even when discharge is performed at a large current and a high speed.

### BRIEF DESCRIPTION OF DRAWINGS

FIG. 1 is a schematic sectional perspective view for illustrating the laminate of a lithium secondary battery according to the present disclosure.

FIG. 2 is a schematic view for illustrating a state in which respective sheets for forming the laminate of the lithium secondary battery according to the present disclosure are stacked.

FIG. 3 is a schematic view for illustrating the position at which a green sheet laminate illustrated in FIG. 2 is cut.

FIG. 4 is a schematic view for illustrating a state in which a collector is added to the laminate illustrated in FIG. 1.

FIG. 5 is a schematic sectional view for illustrating the lithium secondary battery according to the present disclosure.

FIG. 6 is a schematic view for illustrating an aspect in which various green sheets for producing a laminate in a lithium secondary battery of Example 1 are laminated.

FIGS. 7A and 7B are each a schematic perspective view for illustrating the laminate of the lithium secondary battery according to the present disclosure.

### DESCRIPTION OF EMBODIMENTS

### Outline of Embodiments

First, embodiments of the present disclosure are listed and described. A lithium secondary battery of the present disclosure includes a laminate, which includes a plurality of positive electrode layers, a plurality of negative electrode layers, and a plurality of separators, and in which the positive electrode layers and the negative electrode layers are alternately laminated through the separators. The laminate includes a first insulating layer and a second insulating layer. The first insulating layer is arranged in a first end portion of each of the positive electrode layers in a width direction thereof so as to be brought into contact with the positive electrode layer. The second insulating layer is arranged in a second end portion of each of the negative electrode layers in a width direction thereof, the second end portion being positioned on a side opposite to the first end portion in the width direction, so as to be brought into contact with the negative electrode layer. When an external width of the laminate is represented by W, and an average of widths of the first insulating layers and widths of the second insulating layers is represented by wₐᵥₑ, a ratio “(wₐᵥₑ/W)×100” falls within a range of from 0.8 (%) to 40 (%).

There has heretofore been known a lithium secondary battery, which includes a plurality of positive electrode layers and a plurality of negative electrode layers, and in which a plurality of cells are formed in one electrode (e.g., Patent Literature 2). In the laminate of Patent Literature 2, the side margin layer is arranged on the outer peripheral side of each of the positive electrode layers and the negative electrode layers so as to be arranged side by side therewith. The side margin layer is arranged for eliminating a step between the solid electrolyte layer of the battery, and each of the positive electrode layers and the negative electrode layers. In Patent Literature 2, there is a description that the side margin layer improves denseness between the solid electrolyte layer and each of the electrode layers, and hence delamination and warping due to the firing of the all-solid-state battery hardly occur.

Meanwhile, along with the expansion of the applications of a lithium secondary battery, there has been desired a lithium secondary battery that has a small size and a large capacity, and maintains a discharge capacity even in discharge at a large current. An electrode having a laminated structure including a plurality of cells may provide a battery having a small size and a large capacity. However, the inventors have found that when the electrode having a laminated structure is adopted, it is difficult to maintain a rate characteristic even in discharge at a large current while maintaining the capacity. To solve the problem, the inventors have paid attention to the width of an insulating layer arranged in each of the end portions of a positive electrode layer and a negative electrode layer in the electrode having a laminated structure, and have found that the control of the width provides an excellent lithium secondary battery that achieves both of a capacity and a rate characteristic.

Specifically, the lithium secondary battery according to the present disclosure includes an electrode including a laminate, which includes a plurality of positive electrode layers, a plurality of negative electrode layers, and a plurality of separators, and in which the positive electrode layers and the negative electrode layers are alternately laminated through the separators. In addition, insulating layers are arranged laterally to the positive electrode layers and the negative electrode layers so as to be arranged side by side with the respective layers. In the laminate, when the external width of the laminate is represented by W, and the average of the widths of the insulating layers in the laminate is represented by wₐᵥₑ, the ratio of the average wₐᵥₑ of the widths of the insulating layers to the external width W of the laminate falls within the range of from 0.8% to 40%. Without being bound to any particular theory, it has been conceived that the adoption of the range reduces the volume resistivity of the battery, and hence both the capacity and rate characteristic thereof are achieved.

In addition, in the lithium secondary battery, when an average of absolute values of differences between the respective widths of the first insulating layers and the second insulating layers and the average wₐᵥₑ thereof is defined as an average wₛ of variations in insulating layer width, (wₛ/wₐᵥₑ)×100≤20 (%) may be satisfied. When the ratio falls within the range, a lithium secondary battery having a particularly high rate characteristic is obtained.

In addition, in the laminate, the positive electrode layers, the negative electrode layers, the separators, the first insulating layers, and the second insulating layers may be an integrated sintered body that is integrally formed. The use of the integrated sintered body exhibits the following effect: the sintered body is easy to handle, and can be produced at rational cost.

In addition, the lithium secondary battery may further include: an exterior body including a positive electrode can and a negative electrode can; a first collector interposed between the positive electrode can and the positive electrode layers; and a second collector interposed between the negative electrode can and the negative electrode layers. The first collector may extend from a first side surface, which is on a side at which the positive electrode layers are exposed, out of side surfaces of the laminate, to a surface on a side closer to the positive electrode can out of an upper surface and a lower surface of the laminate. The second collector may extend from a second side surface, which is on a side at which the negative electrode layers are exposed, out of the side surfaces of the laminate, to a surface on a side closer to the negative electrode can out of the upper surface and the lower surface of the laminate. Such configuration can reliably establish electrical connection between: an electrode in a so-called coin battery, the electrode being a laminate that has a small thickness and includes a plurality of positive electrodes and a plurality of negative electrodes; and the outside of the battery.

In addition, in the lithium secondary battery, the negative electrode layers may each include a collector layer arranged inside the negative electrode layer in a thickness direction thereof, and the positive electrode layers may each be free of a collector layer arranged inside in a thickness direction thereof. With such configuration, the internal resistance of the battery is reduced, and hence power collection in its negative electrode is secured. In addition, no collector layer is included in its positive electrode having a small volume resistivity, and hence the number of constituent members in the laminate of the battery can be reduced.

### Specific Examples of Embodiments

Next, a specific embodiment of the lithium secondary battery of the present disclosure is described with reference to the drawings. In the following drawings, the same or corresponding portions are given the same reference symbol, and hence their description is not repeated.

### First Embodiment

### (Lithium Secondary Battery)

First, the outline of the lithium secondary battery according to the present disclosure is described. FIG. 5 is an schematic sectional view for illustrating the structure of a lithium secondary battery 10 that is one embodiment according to the present disclosure. In FIG. 5, members of the same kind are represented by the same kind of hatching, and hence the representation of some reference symbols is omitted. The same holds true for any other figure.

With reference to FIG. 5, the lithium secondary battery 10 includes, in an exterior body 24, a plurality of positive electrode layers 12, a plurality of negative electrode layers 16, and a plurality of separators 20, the layers and the separators being laminated. In addition, the lithium secondary battery 10 includes an electrolytic solution 22 sealed in the exterior body 24. The positive electrode layers 12 each include, for example, a sintered body containing lithium cobaltate. The negative electrode layers 16 each include, for example, a titanium-containing sintered body. The separators 20 are each made of ceramic, and are interposed between the positive electrode layers 12 and the negative electrode layers 16. A first insulating layer 11a is arranged in one end portion of each of the positive electrode layers 12 in its width direction so as to be brought into contact with the positive electrode layer 12. A second insulating layer 11b is arranged in one end portion of each of the negative electrode layers 16 in its width direction, the end portion being on a side opposite to the end portion in which the first insulating layer 11a is arranged, so as to be brought into contact with the negative electrode layer 16.

The exterior body 24 includes a closed space, and the positive electrode layers 12, the negative electrode layers 16, the separators 20, and the electrolytic solution 22 are stored in the closed space. The positive electrode layers 12, the negative electrode layers 16, and the separators 20 are impregnated with the electrolytic solution 22.

The positive electrode layers 12, the separators 20, the negative electrode layers 16, and the insulating layers 11a and 11b are one integrated sintered body. That is, the positive electrode layers 12, the separators 20, the negative electrode layers 16, and the insulating layers 11a and 11b are bonded to each other. The term “integrated sintered body” as used herein means that the respective members for forming the sintered body are connected and bonded to each other without relying on any bonding approach (e.g., an adhesive) other than sintering. As another embodiment, the following is permitted: the positive electrode layers 12 and the separators 20 form an integrated sintered body, and the negative electrode layers 16 are each a sintered body formed separately from the integrated fired body.

The exterior body 24 only needs to be appropriately selected in accordance with the type of the lithium secondary battery 10. For example, when the lithium secondary battery is in such a coin-shaped battery form as illustrated in FIG. 5, the exterior body 24 typically includes a positive electrode can 24a, a negative electrode can 24b, and a gasket 24c. The positive electrode can 24a and the negative electrode can 24b are caulked through the gasket 24c to form the closed space. The positive electrode can 24a and the negative electrode can 24b may each be made of a metal such as stainless steel, and are not particularly limited. The gasket 24c may be a circular member made of an insulating resin, such as polypropylene, polytetrafluoroethylene, or a PFA resin, and is not particularly limited.

Although the lithium secondary battery 10 illustrated in FIG. 5 is in a coin-shaped battery form, the form of the lithium secondary battery according to the present disclosure is not limited thereto. For example, other forms such as thin secondary batteries including a chip secondary battery and a pouch secondary battery are permitted. When the lithium secondary battery is a chip battery that can be built in a card, it is preferred that its exterior body include a resin-made substrate, and its battery elements (i.e., the positive electrode layers 12, the negative electrode layers 16, the separators 20, and the electrolytic 22) be embedded in the resin-made substrate. When the lithium secondary battery is a pouch secondary battery, for example, the battery elements may be sandwiched between a pair of resin films. The pair of resin films may be bonded to each other with an adhesive. In addition, in the pair of resin films, the resin films may be thermally fused to each other by hot pressing. Further, the following configuration is permitted: separators each including a solid electrolyte are adopted as the separators, and the separators are each free of an electrolytic solution.

With reference to FIG. 5, the lithium secondary battery 10 includes a positive electrode collector 14 extending from a side surface of its laminated structure to the lower surface thereof. In addition, the lithium secondary battery 10 includes a negative electrode collector 18 extending from another side surface of the laminated structure to the upper surface thereof. The positive electrode collector 14 and the negative electrode collector 18 may each be metal foil, such as copper foil or aluminum foil. The positive electrode collector 14 is preferably arranged between the positive electrode layers 12 and the exterior body 24 (e.g., the positive electrode can 24a). The negative electrode collector 18 is preferably arranged between the negative electrode layers 16 and the exterior body 24 (e.g., the negative electrode can 24b). In addition, a positive electrode-side carbon layer (not shown) is preferably arranged between each of the positive electrode layers 12 and the positive electrode collector 14 from the viewpoint of reducing a contact resistance. Similarly, a negative electrode-side carbon layer (not shown) is preferably arranged between each of the negative electrode layers 16 and the negative electrode collector 18 from the viewpoint of reducing a contact resistance. The positive electrode-side carbon layer and the negative electrode-side carbon layer each preferably include conductive carbon. The carbon layers may each be formed by, for example, applying a conductive carbon paste to the surface of metal foil to be used as a collector.

### (Laminate)

The laminate in the lithium secondary battery according to the present disclosure is described.

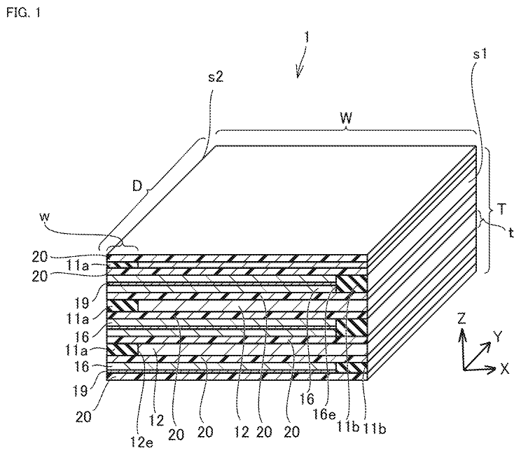

FIG. 1 is a schematic sectional perspective view for illustrating a laminate 1 in the lithium secondary battery according to the present disclosure. With reference to FIG. 1, the laminate 1 is a laminate in which many layers are laminated. The laminate 1 is a rectangular parallelepiped shape whose outer shape is defined by an external width (W), an external depth (D), and an external thickness (T). The term “rectangular parallelepiped” means not only a rectangular parallelepiped in a mathematically correct sense, but also includes a three-dimensional structure having a shape similar to the rectangular parallelepiped because of reasons in terms of design and production. The respective layers for forming the laminate 1 each have a quadrangular plate shape. In the laminate 1, a direction parallel to an X-axis illustrated in FIG. 1 is referred to as “width direction,” a direction parallel to a Y-axis illustrated therein is referred to as “depth direction,” and a direction parallel to a Z-axis illustrated therein is referred to as “height direction.” In this description, surfaces of the laminate 1 at which all the laminated layers are exposed (surfaces illustrated as sections in FIG. 1) are referred to as “front surface” and “back surface.” The front surface and the back surface are surfaces parallel to an XZ plane. In addition, a surface of the laminate 1 at which its laminated structure is exposed, the surface extending between the front surface and the back surface and extending along the depth direction, is referred to as “side surface.”

With reference to FIG. 1, in the laminate 1, the plurality of positive electrode layers 12 and the plurality of negative electrode layers 16 are alternately laminated. The separators 20 are interposed between the positive electrode layers 12 and the negative electrode layers 16. The separators 20 extend over the entirety of the external width W of the laminate 1. In contrast, the width of each of the positive electrode layers 12 and the negative electrode layers 16 is smaller than the external width W of the laminate 1. The positive electrode layers 12 and the negative electrode layers 16 are each exposed only at a side surface on one side of the laminate 1. Specifically, the positive electrode layers 12 are exposed at a first side surface s1 of the laminate 1 in the width direction of the laminate 1, and each extend from the side surface s1 to an end portion 12e of the positive electrode layer 12 serving as a first end portion. An insulating layer 11a serving as a first insulating layer is arranged in contact with the end portion 12e of each of the positive electrode layers 12 so as to be arranged side by side with the positive electrode layer 12. The negative electrode layers 16 are exposed at a second side surface s2 of the laminate 1 in the width direction of the laminate 1, and each extend from the side surface s2 to an end portion 16e of the negative electrode layer 16 serving as a second end portion. An insulating layer 11b serving as a second insulating layer is arranged in contact with the end portion 16e of each of the negative electrode layers 16 so as to be arranged side by side with the negative electrode layer 16.

The positive electrode layers 12, the separators 20, and the second insulating layers 11b are exposed at the first side surface s1 of the laminate 1, and the negative electrode layers 16 are not exposed thereat. Similarly, the negative electrode layers 16, the separators 20, and the first insulating layers 11a are exposed at the second side surface s2 of the laminate 1, and the positive electrode layers 12 are not exposed thereat. According to the configuration, an electrode that efficiently draws electricity from a small lithium secondary battery can be formed by: arranging the positive electrode collector 14 (FIG. 5) on the first side surface s1; and arranging the negative electrode collector 18 (FIG. 5) on the second side surface s2.

The first insulating layers 11a and the second insulating layers 11b may be identical to each other in composition and configuration. The laminate 1 of FIG. 1 includes three first insulating layers 11a and three second insulating layers 11b. That is, the laminate 1 includes six insulating layers 11a and 11b. The insulating layers 11a and 11b each have a width “w”. FIG. 1 is a schematically illustrated figure, and thus all of the six insulating layers 11a and 11b have the same width “w”. However, the widths “w” of the insulating layers vary from insulating layer to insulating layer in some cases depending on, for example, factors in terms of design and production. In addition, the widths of the insulating layers may vary depending on, for example, the positions of the insulating layers. The average of the widths “w” of all the insulating layers in the laminate is defined as the insulating layer width average wₐᵥₑ. In the laminate of FIG. 1, for example, the average of the widths “w” of the six insulating layers is the insulating layer width average wₐᵥₑ. In the example of FIG. 1, the width “w” of each of the insulating layers and the insulating layer width average wₐᵥₑ are equal to each other.

The uppermost layer and lowermost layer of the laminate 1 each include the separator 20. In the laminate 1, the positive electrode layer 12 and the negative electrode layer 16 facing each other through the separator 20 form one cell. In the laminate 1 of FIG. 1, 5 cells are formed. Although the number of cells in the laminate is not limited as long as the laminate has the effect of the invention, a laminate having, for example, 3 to 200 cells may be adopted.

In the laminate 1, the positive electrode layers 12, the negative electrode layers 16, the separators 20, the first insulating layers 11a, and the second insulating layers 11b may be an integrated sintered body that is integrally formed.

The configurations of the respective layers are described next.

### (Positive Electrode Layers)

The positive electrode layers 12 each include a plate-like sintered body containing lithium cobaltate. The positive electrode layers 12 may each be free of a binder and a conductive aid. Lithium cobaltate is specifically, for example, LiCoO₂ (hereinafter sometimes abbreviated as “LCO”). For example, sintered bodies disclosed in JP 5587052 B2 and WO 2017/146088 A1 may each be used as an LCO sintered body to be formed into a plate shape. The positive electrode layers 12 are each preferably the following oriented positive electrode layer: the positive electrode layer contains a plurality of primary particles each including lithium cobaltate, and the plurality of primary particles are oriented at an average orientation angle of more than 0° and 30° or less with respect to the layer surface of the positive electrode layer. Examples of the structure, composition, and identification method of such oriented positive electrode layer include those disclosed in Patent Literature 1 (WO 2019/221144 A1).

Examples of lithium cobaltate for forming the primary particles in each of the positive electrode layers 12 include, in addition to LCO, LiₓNiCoO₂ (lithium nickel cobaltate), LiₓCONiMnO₂ (lithium cobalt nickel manganate), and LiₓCoMnO₂ (lithium cobalt manganate). In addition, the primary particles may each contain any other lithium composite oxide together with lithium cobaltate. The lithium composite oxide is, for example, an oxide represented by LiₓMO₂ (where 0.05<x<1.10 is satisfied, M represents at least one kind of transition metal, and M typically contains one or more kinds of Co, Ni, and Mn).

The average particle diameter of the plurality of primary particles for forming each of the positive electrode layers 12 is preferably 5 μm or more. Specifically, the average particle diameter of the primary particles to be used in the calculation of the average orientation angle is preferably 5 μm or more, more preferably 7 μm or more, still more preferably 12 μm or more.

The positive electrode layers 12 may each include pores. When a sintered body includes pores, in particular, open pores, in the case where the sintered body is incorporated as a positive electrode layer into a battery, an electrolytic solution can be caused to permeate into the sintered body, and as a result, lithium ion conductivity can be improved. A porosity in each of the positive electrode layers 12 is preferably from 20% to 60%, more preferably from 25% to 55%, still more preferably from 30% to 50%, particularly preferably from 30% to 45%. The porosity of a sintered body may be measured in accordance with a known method.

The average pore diameter of each of the positive electrode layers 12 is preferably from 0.1 μm to 10.0 μm, more preferably from 0.2 μm to 5.0 μm, still more preferably from 0.25 μm to 3.0 μm. When the average pore diameter falls within the above-mentioned ranges, the occurrence of local stress concentration in a large pore is suppressed, and hence stress in the sintered body is uniformly released with ease. In addition, an improvement in lithium ion conductivity by the permeation of the electrolytic solution into the sintered body through its pores can be more effectively achieved.

Although the thickness of each of the positive electrode layers 12 in the laminate 1 is not particularly limited, the thickness is, for example, preferably from 2 μm to 80 μm, more preferably from 4 μm to 60 μm, still more preferably from 10 μm to 40 μm. When the thickness falls within such ranges, the electronic resistance of the layer is suppressed, and the transfer resistance of a Li ion in the electrolytic solution is also suppressed. Thus, the resistance of the battery can be reduced.

### (Separators)

The separators 20 each include a ceramic-made fine porous membrane. The separators 20 each contain magnesia (MgO). Specifically, the separators may each include, for example, magnesia (MgO) and glass. In each of the separators 20, MgO and the glass are present in particle forms bonded to each other by sintering. The ceramic in each of the separators 20 may contain, for example, Al₂O₃, ZrO₂, SiC, Si₃N₄, or AlN in addition to MgO and the glass.

The glass in each of the separators 20 contains preferably 25 wt % or more, more preferably 30 wt % to 95 wt %, still more preferably 40 wt % to 90 wt %, particularly preferably 50 wt % to 80 wt % of SiO₂. The content of the glass in each of the separators 20 is preferably from 3 wt % to 70 wt %, more preferably from 5 wt % to 50 wt %, still more preferably from 10 wt % to 40 wt %, particularly preferably from 15 wt % to 30 wt % with respect to the total weight of the separator 20. When the content falls within the ranges, both of a high yield and an excellent charge-discharge cycle characteristic can be effectively achieved. The addition of a glass component to each of the separators 20 is preferably performed by adding a glass frit to raw material powder for the separator. The glass frit preferably contains one or more of Al₂O₃, B₂O₃, and BaO as a component except SiO₂.

Although the thickness of each of the separators 20 in the laminate 1 is not particularly limited, the thickness is, for example, preferably from about 5 μm to about 50 μm, more preferably from about 10 μm to about 30 μm. Although the porosity of each of the separators 20 is also not particularly limited, the porosity may be set to, for example, from about 30% to about 70%, and is preferably from about 40% to about 60%.

### (Negative Electrode Layers)

The negative electrode layers 16 each include, for example, a plate-like sintered body containing a titanium-containing composition. The negative electrode layers 16 may each be free of a binder and a conductive aid. The titanium-containing sintered body preferably contains lithium titanate Li₄Ti₅O₁₂ (hereinafter “LTO”) or a niobium-titanium composite oxide Nb₂TiO₇, and more preferably contains LTO. Although it has been known that LTO typically has a spinel structure, LTO may have any other structure at the time of the charge and discharge of the lithium secondary battery. For example, in LTO, a reaction advances at the time of the charge and the discharge under a state in which two phases, that is, Li₄Ti₅O₁₂ (spinel structure) and Li₇Ti₅O₁₂ (rock salt structure) coexist. Accordingly, the structure of LTO is not limited to the spinel structure. Part of LTO may be substituted with any other element. Examples of the other element include Nb, Ta, W, Al, and Mg. The LTO sintered body may be produced in accordance with, for example, a method described in JP 2015-185337 A.

The negative electrode layers 16 each have a structure in which a plurality of (i.e., many) primary particles are bonded to each other. Those primary particles each preferably include LTO or Nb₂TiO₇. The negative electrode layers 16 may be formed as an integrated sintered body together with the positive electrode layers 12 and the separators 20. In addition, the following may be performed: the negative electrode layers 16 are formed as a sintered body different from the integrated sintered body of the positive electrode layers 12 and the separators 20; and then, the sintered bodies are combined with each other.

Although the thickness of each of the negative electrode layers 16 in the laminate 1 is not particularly limited, the thickness is, for example, preferably from 1 μm to 40 μm, more preferably from 2 μm to 30 μm, still more preferably from 5 μm to 20 μm. A primary particle diameter that is the average particle diameter of the plurality of primary particles for forming each of the negative electrode layers 16 is preferably 1.2 μm or less, more preferably from 0.02 μm to 1.2 μm, still more preferably from 0.05 μm to 0.7 μm.

The negative electrode layers 16 each preferably include pores. When a sintered body includes pores, in particular, open pores, in the case where the sintered body is incorporated as a negative electrode layer into a battery, an electrolytic solution can be caused to permeate into the sintered body, and as a result, lithium ion conductivity can be improved. A porosity in each of the negative electrode layers 16 is preferably from 20% to 60%, more preferably from 30% to 55%, still more preferably from 35% to 50%. The average pore diameter of each of the negative electrode layers 16 is preferably from 0.08 μm to 5.0 μm, more preferably from 0.1 μm to 3.0 μm, still more preferably from 0.12 μm to 1.5 μm.

In the laminate 1, the negative electrode layers 16 may each include a collector layer 19. The collector layer 19 may be arranged inside each of the negative electrode layers 16 in its thickness direction, or may be formed so as to be exposed at one of the main surfaces of the negative electrode layer 16. The collector layer 19 may include a material excellent in conductivity. The collector layer 19 may include, for example, gold, silver, platinum, palladium, aluminum, copper, or nickel. The incorporation of the collector layer 19 can reduce the internal resistance of the laminate, in particular, that in its negative electrode.

### (Insulating Layers)

The insulating layers 11a and 11b each include a ceramic-made fine porous membrane. The insulating layers 11a and 11b each contain magnesia (MgO). Specifically, the insulating layers may each include, for example, magnesia (MgO) and TiO₂. In each of the insulating layers 11a and 11b, MgO and TiO₂ are present in particle forms bonded to each other by sintering. The ceramic in each of the insulating layers 11a and 11b may contain, for example, Al₂O₃, ZrO₂, SiC, Si₃N₄, or AlN in addition to MgO and TiO₂. The insulating layers 11a and 11b may be layers identical in composition to each other. In addition, the insulating layers 11a and 11b, and the separators 20 may be formed of materials having the same composition.

The thicknesses of the insulating layers 11a and 11b in the laminate 1 are not particularly limited. The thicknesses of the insulating layers 11a and 11b are each preferably the same as that of the positive electrode layer 12 or the negative electrode layer 16 so as to be arranged side by side with the insulating layer 11a or 11b. The porosities of the insulating layers 11a and 11b are also not particularly limited. Each of the porosities may be set to, for example, from about 20% to about 70%, and is preferably from about 30% to about 60%.

### Second Embodiment

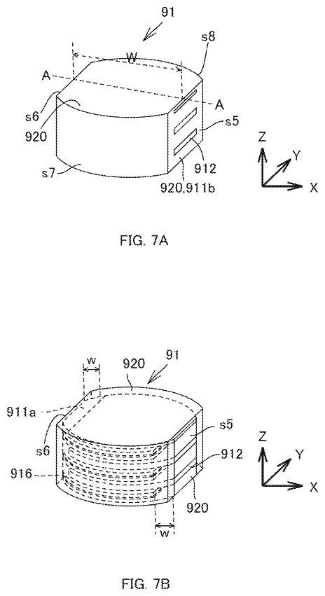

A schematic perspective view of a laminate 91 according to a second embodiment is illustrated in each of FIGS. 7A and 7B. FIG. 7A is a perspective view for illustrating the appearance of the laminate 91, and FIG. 7B is a schematic view for illustrating a laminated structure inside the laminate 91. As in the laminate 1 illustrated in FIG. 1, in the laminate 91 illustrated in each of FIGS. 7A and 7B, a direction parallel to an X-axis is referred to as “width direction,” a direction parallel to a Y-axis is referred to as “depth direction,” and a direction parallel to a Z-axis is referred to as “height direction.”

In the first embodiment, the laminate 1 has a rectangular parallelepiped shape. However, the shape of the laminate is not limited to a rectangular parallelepiped shape. In the laminate 91 according to the second embodiment, a section perpendicular to its lamination direction has a shape obtained by cutting off part of a circle. More specifically, in the laminate 91, the shape of the section perpendicular to the lamination direction includes: two sides that are two straight lines parallel to each other; and two arcs connecting the ends of the two sides. From another viewpoint, the laminate 91 has the following shape: part of a cylinder is cut off parallel to its tangent, and a first side surface s5 and a second side surface s6 that are two flat surfaces facing each other are formed on the side surfaces of the cylinder. The shape is referred to as “round shape.” The entirety of each of surfaces s7 and s8 that are the arc-shaped side surfaces of the laminate 91 includes a separator 920.

With reference to FIG. 7A and FIG. 7B, a positive electrode layer 912, a separator 920, and a second insulating layer 911b are exposed at the first side surface s5, and a negative electrode layer 916 is not exposed thereat. The separator 920 and the second insulating layer 911b have the same composition, and become an integrated layer after their firing. Accordingly, the separator and the layer are represented as an integrated layer in FIG. 7A. In addition, the negative electrode layer 916, the separator 920, and a first insulating layer 911a are exposed at the second side surface s6, and the positive electrode layer 912 is not exposed thereat.

In the laminate 91, the first insulating layer 911a is arranged in an end portion of the positive electrode layer 912 in the width direction so as to be brought into contact with the positive electrode layer 912. The width “w” of the first insulating layer 911a is a length from the end portion of the positive electrode layer 912 in the width direction (X-axis direction) to the side surface s6. The width “w” of the second insulating layer 911b is a length from an end portion of the negative electrode layer 916 in the width direction (X-axis direction) to the side surface s5. That is, when the laminate 91 has a round shape, the external width W of the laminate, and the width “w” of each of the first insulating layer and the second insulating layer are defined in the section A-A perpendicular to the first side surface s5 and the second side surface s6. The section A-A is a section of the laminate 91 taken along the width direction (X-axis direction).

Even in the case where the laminate 91 has a round shape as illustrated in each of FIGS. 7A and 7B, when the external width of the laminate 91 is represented by W, and the average of the widths “w” of the first insulating layers and the widths “w” of the second insulating layers is represented by wₐᵥₑ, the laminate is formed so that (wₐᵥₑ/W)×100=0.8 to 40 (%) may be satisfied.

### (Production Method)

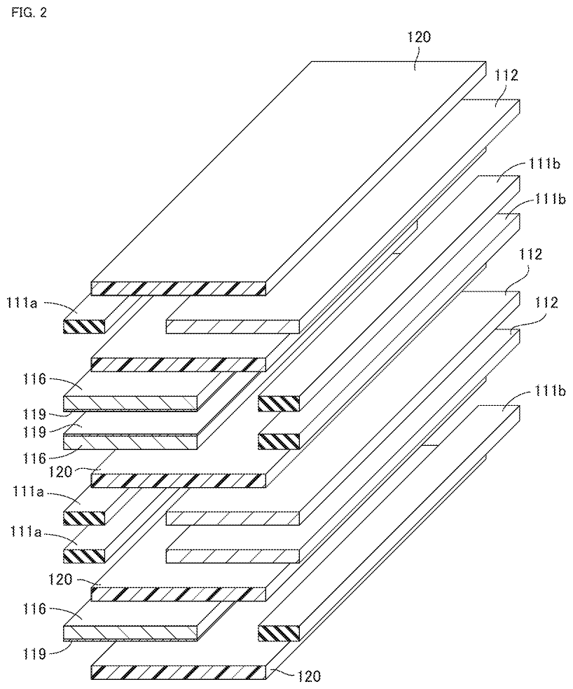

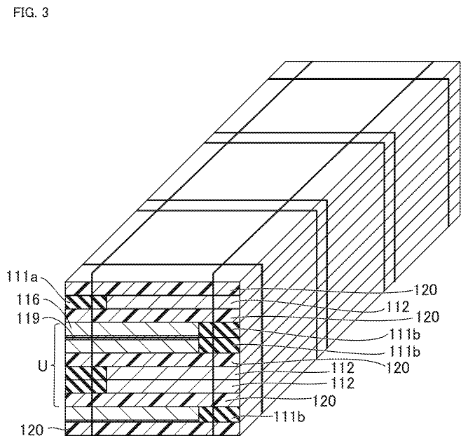

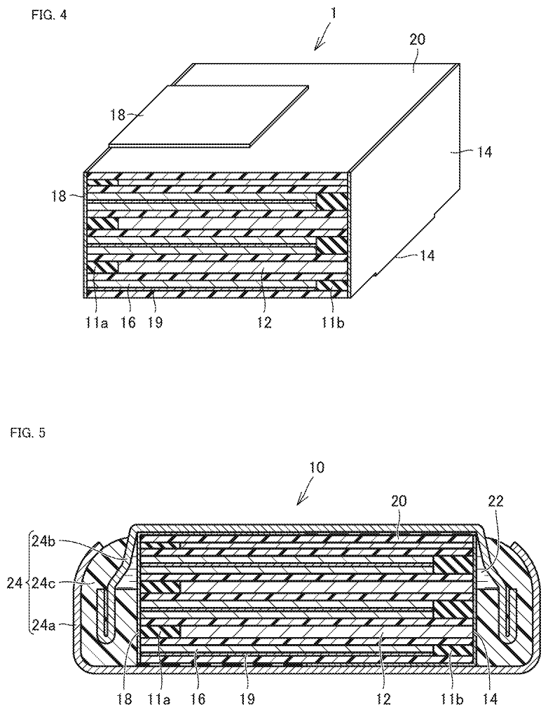

The outline of a method of producing the laminate in the lithium secondary battery according to the present disclosure is described. FIG. 2 is a schematic view for illustrating a state in which respective sheets for forming the laminate are stacked. FIG. 3 is a schematic view for illustrating the position at which the sheet laminate illustrated in FIG. 2 is cut. FIG. 4 is a schematic view for illustrating a state in which a positive electrode collector and a negative electrode collector are added to the resultant laminate.

With reference to FIG. 2, a positive electrode green sheet 112, a negative electrode green sheet 116, a separator green sheet 120, a first insulating layer green sheet (positive electrode-side green sheet) 111a, and a second insulating layer green sheet (negative electrode-side green sheet) 111b serving as materials for forming the laminate are each separately prepared. Typically, first, a slurry containing a raw material for forming each layer is prepared, and then, the prepared slurry is formed into a sheet shape on a resin film. Thus, a green sheet can be prepared. A collector layer 119 may be formed on one of the main surfaces of the negative electrode green sheet 116. The respective sheets each cut into a predetermined width are sequentially stacked so that a predetermined layer configuration may be obtained.

At the time of the stacking, the positive electrode green sheet 112 and the first insulating layer green sheet (positive electrode-side green sheet) 111a are arranged so that the sheets may be adjacent to each other to form one layer. In addition, the negative electrode green sheet 116 and the second insulating layer green sheet (negative electrode-side green sheet) 111b are arranged so that the sheets may be adjacent to each other to form one layer. The separator green sheet 120 is arranged so as to form one layer alone over the entirety of the width direction of the laminate to be obtained. The positive electrode green sheet 112 and the first insulating layer green sheet 111a may each be used alone in the thickness direction of the laminate, or a form in which two or more sheets of the same kind are continuously superimposed in the thickness direction is also permitted. Similarly, the negative electrode green sheet 116 and the second insulating layer green sheet 111b may each be used alone in the thickness direction, or two or more sheets of the same kind may be continuously superimposed in the thickness direction. When two or more sheets of the same kind are superimposed in the thickness direction, the superimposed sheets are integrated in their sintering stage, and hence become one layer in a sintered body. When the two negative electrode green sheets 116 each having the collector layer 119 are superimposed, the sheets are preferably superimposed so that the collector layers 119 may be brought into contact with each other.

In the resultant green sheet laminate, the green sheets can be pressure-bonded to each other by pressing. The pressing may be performed by, for example, cold isostatic pressing (CIP), warm isostatic pressing (WIP), or isostatic pressing, and a method therefor is not particularly limited. The pressing may be performed while the laminate is heated.

Subsequently, the green sheet laminate is cut. With reference to FIG. 3, the following only needs to be performed: both the side surfaces of the green sheet laminate are cut so that a predetermined width may be obtained, and the remainder is vertically cut in its length direction so that a laminate having a predetermined depth may be obtained. A lamination form and a cutting site only need to be set in accordance with a desired sintered body form (entire dimensions, and the widths and thicknesses of its respective layers). Although a layer configuration is simply illustrated in the example of FIG. 3, a unit U including the negative electrode green sheet 116 and the second insulating layer green sheet 111b, the separator green sheet 120, the positive electrode green sheet 112 and the first insulating layer green sheet 111a, and the separator green sheet 120 in the stated order may be repeatedly laminated to provide a laminate having a larger number of layers. The green sheet laminate cut into a predetermined shape is degreased and fired to provide a laminate that is a laminated integrated sintered body. The degreasing and the firing may be performed under known conditions and by known methods. The thicknesses and widths of the respective layers in the resultant laminated integrated sintered body may be determined by, for example, polishing the laminated integrated sintered body with a cross section polisher, and observing the resultant section with a SEM.

Subsequently, collectors are attached to both the side surfaces of the laminated integrated sintered body. With reference to FIG. 4, the positive electrode collector 14 is attached to the side surface on the side at which the positive electrode layers 12 are exposed, and the negative electrode collector 18 is attached to the side surface on the side at which the negative electrode layers 16 are exposed. A conductive material may be used as the positive electrode collector 14 or the negative electrode collector 18, and for example, aluminum foil or copper foil only needs to be used. The positive electrode collector 14 may be attached so as to cover the entirety of one side surface of the laminate 1, and may be caused to extend to the lower surface of the laminate 1. The negative electrode collector 18 may be attached so as to cover the entirety of the other side surface of the laminate 1, and may be caused to extend to the upper surface of the laminate 1. The positive electrode layers 12 and the positive electrode collector 14, or the negative electrode layers 16 and the negative electrode collector 18 may be bonded to each other with a conductive adhesive. For example, a conductive carbon paste may be used as the conductive adhesive. The thickness of a conductive adhesive layer is not particularly limited as long as an effect as an adhesive layer is exhibited, and the effect of the invention is not inhibited. However, the thickness may be set to, for example, from about 1 μm to about 500 μm.

An electrode obtained by the above-mentioned production method is placed inside an exterior body by using a known method and under known conditions, and an electrolytic solution is sealed therein. Thus, the lithium secondary battery can be obtained.

The width, depth, and height of the laminate that is a laminated integrated sintered body may be appropriately selected in accordance with the desired shape of the lithium secondary battery, and are not particularly limited. For example, when a coin battery is formed, the width, depth, and height of the laminate may be set to from about 3 mm to about 18 mm, from about 3 mm to about 18 mm, and from about 0.3 mm to about 5 mm, respectively. 3 to 200 cells may be formed in the laminate.

### (Electrolytic Solution)

With reference to FIG. 5, the lithium secondary battery 10 may include the electrolytic solution 22. The electrolytic solution 22 is not particularly limited, and an electrolytic solution known as an electrolytic solution in a lithium secondary battery may be used. For example, one kind or a combination of two or more kinds selected from ethylene carbonate (EC), methyl ethyl carbonate (MEC), diethyl carbonate (DEC), ethyl methyl carbonate (EMC), propylene carbonate (PC), and γ-butyrolactone (GBL) may be used as a solvent. A lithium salt compound, such as lithium hexafluorophosphate (LiPF₆) or lithium tetrafluoroborate (LiBF₄), may be used as an electrolyte to be dissolved in the solvent. The electrolytic solution 22 may further contain at least one kind selected from vinylene carbonate (VC), fluoroethylene carbonate (FEC), vinylethylene carbonate (VEC), and lithium difluoro (oxalato) borate (LiDFOB) as an additive.

The concentration of the electrolyte in the electrolytic solution 22 is preferably from 0.5 mol/L to 2 mol/L, more preferably from 0.6 mol/L to 1.9 mol/L, still more preferably from 0.7 mol/L to 1.7 mol/L, particularly preferably from 0.8 mol/L to 1.5 mol/L.

In addition to the electrolytic solution 22, a solid electrolyte or a polymer electrolyte may be used as the electrolyte. In that case, as in the case of the electrolytic solution 22, at least the inside of each of the pores of the separators 20 is preferably impregnated with the electrolyte. Although a method for the impregnation is not particularly limited, examples thereof include: a method including melting the electrolyte to cause the electrolyte to infiltrate into the pores of the separators 20; and a method including pressing the compact of the electrolyte against the separators 20.

### EXAMPLES

The lithium secondary battery of the present disclosure is described in more detail below by way of Examples and Comparative Examples.

### Example 1

A lithium secondary battery was produced in accordance with a method described in the following sections 1 to 7. The resultant lithium secondary battery was evaluated by methods described in the sections 8 and 9.

### 1. Production of Laminate

The green sheets of respective layers for forming a laminate were produced under conditions described in the sections (1) to (5) and by methods described therein. In each of the sections (1) to (5), the viscosity of a slurry was measured with an LVT viscometer manufactured by Brookfield Engineering. At the time of the molding of the slurry on a PET film, a doctor blade method was used.

### (1) Production of LCO Green Sheet (Positive Electrode Green Sheet)

Co₃O₄ powder (manufactured by Seido Chemical Industry Co., Ltd.) and Li₂CO₃ powder (manufactured by the Honjo Chemical Corporation) weighed so that the molar ratio “Li/Co” became 1.01 were mixed, and then, the mixture was held at 780° C. for 5 hours. The resultant powder was pulverized in a pot mill so that a volume-based D₅₀ particle diameter became 0.4 μm. Thus, powder formed of LCO plate-like particles was obtained. 100 Parts by weight of the resultant LCO powder, 100 parts by weight of a dispersion medium (toluene:isopropanol=1:1), 8 parts by weight of a binder (polyvinyl butyral: product number: BM-2, manufactured by Sekisui Chemical Co., Ltd.), 2 parts by weight of a plasticizer (di(2-ethylhexyl) phthalate (DOP), manufactured by Kurogane Kasei Co., Ltd.), and 4.5 parts by weight of a dispersant (product name: RHEODOL SP-O30, manufactured by Kao Corporation) were mixed. The resultant mixture was stirred under reduced pressure to be defoamed, and its viscosity was adjusted to 4,000 cP. Thus, an LCO slurry was prepared. The prepared slurry was molded into a sheet shape on the PET film. Thus, an LCO green sheet was formed. The thickness of an LCO layer after its firing was adjusted to 12 μm.

### (2) Production of LTO Green Sheet (Negative Electrode Green Sheet)

100 Parts by weight of LTO powder (volume-based D₅₀ particle diameter: 0.06 μm, manufactured by Sigma-Aldrich Japan K.K.), 100 parts by weight of a dispersion medium (toluene:isopropanol=1:1), 20 parts by weight of a binder (polyvinyl butyral: product number: BM-2, manufactured by Sekisui Chemical Co., Ltd.), 4 parts by weight of a plasticizer (di(2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant mixture of negative electrode raw materials was stirred under reduced pressure to be defoamed, and its viscosity was adjusted to 4,000 cP. Thus, an LTO slurry was prepared. The prepared slurry was molded into a sheet shape on the PET film. Thus, an LTO green sheet was formed. The thickness of an LTO layer after its firing was adjusted to 10 μm.

### (2′) Formation of Collector Layer

A Au paste (manufactured by Tanaka Kikinzoku Kogyo K.K., product name: GB-2706) was printed on one surface of the LTO green sheet produced in the section (2) with a printer. The thickness of the printed layer after its firing was set to 0.2 μm.

### (3) Production of Separator Green Sheet

Magnesium carbonate powder (manufactured by Konoshima Chemical Co., Ltd.) was thermally treated at 900° C. for 5 hours to provide MgO powder. The resultant MgO powder and a glass frit (manufactured by Nippon Frit Co., Ltd., CK0199) were mixed at a weight ratio of 7:3. 100 Parts by weight of the resultant mixture powder (volume-based D₅₀ particle diameter: 0.4 μm), 100 parts by weight of a dispersion medium (toluene:isopropanol=1:1), 30 parts by weight of a binder (polyvinyl butyral: product number: BM-2, manufactured by Sekisui Chemical Co., Ltd.), 6 parts by weight of a plasticizer (di(2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant raw material mixture was stirred under reduced pressure to be defoamed, and its viscosity was adjusted to 4,000 cP. Thus, a slurry was prepared. The prepared slurry was molded into a sheet shape on the PET film. Thus, a separator green sheet was formed. The thickness of a separator layer after its firing was set to 25 μm.

### (4) Production of First Insulating Layer (Positive Electrode-Side Insulating Layer) Green Sheet

Magnesium carbonate powder (manufactured by Konoshima Chemical Co., Ltd.) was thermally treated at 900° C. for 5 hours to provide MgO powder. The resultant MgO powder and TiO₂ (manufactured by Ishihara Sangyo Kaisha, Ltd., CR-EL) were mixed at a weight ratio of 6:4. 100 Parts by weight of the resultant mixture powder (volume-based D₅₀ particle diameter: 0.4 μm), 100 parts by weight of a dispersion medium (toluene:isopropanol=1:1), 30 parts by weight of a binder (polyvinyl butyral: product number: BM-2, manufactured by Sekisui Chemical Co., Ltd.), 6 parts by weight of a plasticizer (di(2-ethylhexyl) phthalate (DOP), manufactured by Kurogane Kasei Co., Ltd.), and 2 parts by weight of a dispersant (product name: RHEODOL SP-O30, manufactured by Kao Corporation) were mixed. The resultant raw material mixture was stirred under reduced pressure to be defoamed, and its viscosity was adjusted to 4,000 cP. Thus, a slurry was prepared. The prepared slurry was molded into a sheet shape on the PET film. Thus, a first insulating layer green sheet was formed. The thickness of a first insulating layer after its firing was set to 12 μm.

### (5) Production of Second Insulating Layer (Negative Electrode-Side Insulating Layer) Green Sheet

A slurry was prepared in the same manner as in the section (4). The prepared slurry was molded into a sheet shape on the PET film. Thus, a second insulating layer green sheet was formed. The thickness of a second insulating layer after its firing was set to 10 μm.

### 2. Cutting of Sheets

The respective green sheets obtained in the section 1. were cut into the following widths.

| | | | |
|---|---|---|---|
| (1) | LCO green sheet (positive electrode green sheet) | 7,460 | μm |
| (2) | LTO green sheet (negative electrode green sheet) | 7,460 | μm |
| (3) | Separator green sheet | 10,000 | μm |
| (4) | First insulating layer (positive electrode-side | 2,540 | μm |
| | insulating layer) green sheet | | |
| (5) | Second insulating layer (negative electrode- | 2,540 | μm |
| | side insulating layer) green sheet | | |

### 3. Lamination, Pressure Bonding, Cutting, and Firing

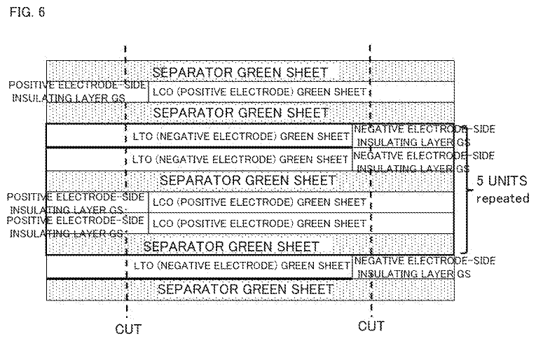

Various green sheets were laminated as illustrated in [FIG. 6]. When two LTO green sheets were superimposed, the lamination was performed so that their collector layers were brought into contact with each other. The resultant laminate was pressed by cold isostatic pressing (CIP) at 100 kgf/cm² so that the green sheets were pressure-bonded to each other. Thus, an unfired green sheet laminate was obtained. Subsequently, the unfired green sheet laminate was cut with a Thomson blade as illustrated in [FIG. 3]. In the cutting, both the ends of the laminate in its width direction were each cut by 2,500 μm, and the depth thereof was set to a length of 5,000 μm. The unfired laminate after the cutting was fired as follows: its temperature was increased from room temperature to 600° C., and the laminate was degreased for 5 hours; and then, the temperature was increased to 800° C. and held for 10 minutes. After that, the laminate was cooled. Thus, a laminated integrated sintered body was obtained. The number of cells to be formed in the laminated integrated sintered body is 11.

### 4. Preparation of Conductive Carbon Paste

A binder (CMC: MAC350HC, manufactured by Nippon Paper Industries Co., Ltd.) was weighed so that its concentration became 1.2 wt % with respect to pure water, followed by its dissolution in the water through mixing with a stirrer. Thus, a 1.2 wt % CMC solution was obtained. A carbon dispersion liquid (product number: BPW-229, manufactured by Nippon Graphite Industries, Co., Ltd.) and a dispersing material solution (product number: LB-300, manufactured by Showa Denko K.K.) were prepared. Subsequently, the carbon dispersion liquid, the dispersing material solution, and the 1.2 wt % CMC solution were weighed so that their ratio became 0.22:0.29:1, followed by the mixing of the materials with a rotary and revolutionary mixer. Thus, a conductive carbon paste was prepared.

### 5. Joining of Positive Electrode-Exposed Surface of Laminated Integrated Sintered Body and Aluminum Foil Via Conductive Carbon Paste

The conductive carbon paste obtained in the section 4. was printed on aluminum foil serving as a positive electrode collector by screen printing. The laminated integrated sintered body obtained in the section 3. was mounted so that its positive electrode-exposed surface was bonded within the undried printed pattern (region having applied thereto the conductive carbon paste). The sintered body was lightly pressed down with a finger, and then, the resultant was dried in a vacuum at 50° C. for 60 minutes. Thus, the positive electrode-exposed surface of the laminated integrated sintered body and the positive electrode collector were bonded to each other via the conductive carbon adhesion layer. The thickness of the conductive carbon adhesive layer was set to 30 μm.

### 6. Joining of Negative Electrode-Exposed Surface of Laminated Integrated Sintered Body and Aluminum Foil Via Conductive Carbon Paste

Aluminum foil serving as a negative electrode collector was bonded to the negative electrode-exposed surface of the laminated integrated sintered body via a conductive carbon adhesion layer in the same manner as in the section 5.

### 7. Production of Lithium Secondary Battery

The positive electrode collector, the laminated integrated sintered body, and the negative electrode collector were placed between a positive electrode can and a negative electrode can, which were intended to form a battery case, so that the collectors and the sintered body were laminated in the stated order from the positive electrode can to the negative electrode can, followed by the loading of an electrolytic solution. After that, the positive electrode can and the negative electrode can were sealed by caulking through a gasket. Thus, a lithium secondary battery of a coin cell form having a diameter of 20 mm and a thickness of 1.6 mm was produced. A liquid obtained as follows was used as the electrolytic solution: propylene carbonate (PC) and γ-butyrolactone (GBL) were mixed at a volume ratio of 1:3; and LiPF₆ was dissolved in the resultant organic solvent so that its concentration became 1.5 mol/L.

### 8. Evaluation 1: Measurement and Calculation of Laminated Integrated Sintered Body

### (1) Measurement of External Width of Laminated Integrated Sintered Body

The external width (W) of the laminated integrated sintered body was measured with a one-shot 3D shape-measuring machine (manufactured by Keyence Corporation, VR-3000).

### (2) Calculation of Respective Parameters

The average wₐᵥₑ of the widths of 12 insulating layers in the laminated integrated sintered body was calculated. The ratio (%) of the insulating layer width average wₐᵥₑ to the external width W was calculated from the following equation.

Insulating layer width average/external width [%]=(wₐᵥₑ/W)×100

A difference between the width of each of the 12 insulating layers and the insulating layer width average wₐᵥₑ was calculated for each of the insulating layers, and the average of the differences was defined as “average wₛ of variations in insulating layer width.” The ratio (%) of the average wₛ of variations in insulating layer width to the insulating layer width average wₐᵥₑ was calculated from the following equation.

Insulating layer width variation average/insulating layer width average [%]=(wₛ/wₐᵥₑ)×100

### 9. Battery Characteristic Evaluation

### (1) Evaluation of 0.2 C Discharge Capacity

The battery capacity of the resultant battery was determined in an environment at 25° C. The battery was charged at a constant current of 0.2 C, and the charge was performed until its voltage reached 2.7 V. The battery was discharged at a constant current of 0.2 C, and the discharge was performed until its voltage reached 1.5 V. The second cycle of charge and discharge was performed under the same conditions as those of the first cycle, and a discharge capacity in the second cycle was defined as a 0.2 C discharge capacity.

### (2) Evaluation of 30 C Discharge Capacity

The battery was charged at a constant current of 0.2 C, and the charge was performed until its voltage reached 2.7 V. The battery was discharged at a constant current of 30 C, and the discharge was performed until its voltage reached 1.5 V.

### (3) Evaluation of Rate Characteristic

The ratio of the 30 C discharge capacity to the 0.2 C discharge capacity was calculated.

### Example 2 to Example 10, and Comparative Examples 1 and 2

Lithium secondary batteries were each produced in the same manner as in Example 1 except that the average and variation average of the widths of the insulating layers were set as shown in [Table 1], and the batteries were similarly subjected to measurement and battery characteristic evaluations. A sample having a predetermined insulating layer width average and a predetermined variation average was obtained as follows: at the time of the lamination and cutting of green sheets, the position at which a positive electrode green sheet and a positive electrode-side insulating layer green sheet (a negative electrode green sheet and a negative electrode-side insulating layer green sheet) were aligned was adjusted, and the position of the cutting was adjusted.

TABLE 1

| | | | | | Insulating |
|---|---|---|---|---|---|
| | | | | | layer |
| | | | | | width |
| | | | | Insulating | variation |
| | | | | layer | average |
| | | | | width | (Wₛ)/ |
| | | Insulating | | average | Insulating |
| | | layer | | (Wₐᵥₑ)/ | layer |
| | External | width | | External | width |
| | width | average | | width | average |
| | (W) | (Wₐᵥₑ) | | (W) | (Wₐᵥₑ) |
| Comparative | 5,000 μm | 25 | μm | 0.5% | 20% |
| Example 1 | | | | | |
| Example 1 | 5,000 μm | 40 | μm | 0.8% | 20% |
| Example 2 | 5,000 μm | 250 | μm | 5.0% | 20% |
| Example 3 | 5,000 μm | 500 | μm | 10.0% | 20% |
| Example 4 | 5,000 μm | 1,000 | μm | 20.0% | 20% |
| Example 5 | 5,000 μm | 1,500 | μm | 30.0% | 20% |
| Example 6 | 5,000 μm | 2,000 | μm | 40.0% | 20% |
| Comparative | 5,000 μm | 2,500 | μm | 50.0% | 20% |
| Example 2 | | | | | |
| Example 7 | 5,000 μm | 250 | μm | 5.0% | 15% |
| Example 8 | 5,000 μm | 250 | μm | 5.0% | 50% |
| Example 9 | 5,000 μm | 250 | μm | 5.0% | 40% |
| Example 10 | 5,000 μm | 250 | μm | 5.0% | 30% |

The evaluation results of the lithium secondary batteries of Examples 1 to 10, and Comparative Examples 1 and 2 are summarized in [Table 2].

TABLE 2

| | | Insulating | | | |
|---|---|---|---|---|---|
| | | layer | | | |
| | | width | | | |
| | Insulating | variation | | 30 C. | |
| | layer | average/ | | discharge | |
| | width | Insulating | | capacity/ | |
| | average/ | layer | 0.2 C. | 0.2 C. | Compre- |
| | External | width | discharge | discharge | hensive |
| | width | average | capacity | capacity | evaluation |
| Comparative | 0.5% | 20% | 0.49 mAh | 58% | X |
| Example 1 | | | | | |
| Example 1 | 0.8% | 20% | 0.48 mAh | 80% | ⊚ |
| Example 2 | 5.0% | 20% | 0.45 mAh | 81% | ⊚ |
| Example 3 | 10.0% | 20% | 0.40 mAh | 82% | ⊚ |
| Example 4 | 20.0% | 20% | 0.31 mAh | 83% | ⊚ |
| Example 5 | 30.0% | 20% | 0.22 mAh | 84% | ⊚ |
| Example 6 | 40.0% | 20% | 0.13 mAh | 85% | ⊚ |
| Comparative | 50.0% | 20% | 0.04 mAh | 82% | X |
| Example 2 | | | | | |
| Example 7 | 5.0% | 15% | 0.45 mAh | 82% | ⊚ |
| Example 8 | 5.0% | 50% | 0.43 mAh | 62% | ◯ |
| Example 9 | 5.0% | 40% | 0.44 mAh | 65% | ◯ |
| Example 10 | 5.0% | 30% | 0.44 mAh | 67% | ◯ |

As shown in Table 2, in each of Examples 1 to 10 in which the ratio of the insulating layer width average to the external width fell within the range of from 0.8% to 40%, the ratio of the 30 C discharge capacity to the 0.2 C discharge capacity was 60% or more, and hence the battery had a satisfactory rate characteristic. In addition, the 0.2 C discharge capacity was 0.13 mAh or more. Accordingly, it was conceived that a large capacity was obtained even in high-speed discharge at a large current. In each of Examples 1 to 7 in which the ratio of the insulating layer width average to the external width fell within the range of from 0.8% to 40%, and the ratio “insulating layer width variation average/insulating layer width average” was 20% or less out of those examples, the ratio of the 30 C discharge capacity to the 0.2 C discharge capacity was 80% or more, and hence the battery showed a particularly excellent rate characteristic. Meanwhile, in Comparative Example 1 in which the ratio of the insulating layer width average to the external width was 0.5%, the ratio of the 30 C discharge capacity to the 0.2 C discharge capacity was 58%, and hence it was conceived that the rate characteristic was insufficient. In addition, in Comparative Example 2 in which the ratio of the insulating layer width average to the external width was 50%, the 0.2 C discharge capacity was 0.04 mAh, and hence it was conceived that the battery did not have any sufficient battery capacity.

Further, it was conceived from comparison between Examples 2 and 7 to 10 in each of which the ratio of the insulating layer width average to the external width was 5.0% that when the ratio “insulating layer width variation average/insulating layer width average” was small (specifically, when the ratio was 20% or less), the battery showed a particularly excellent rate characteristic.

It is to be understood that the embodiments disclosed herein are merely examples in all aspects and in no way intended to limit the present disclosure. The scope of the present disclosure is defined by the appended claims and not by the above description, and it is intended that the present disclosure encompasses all modifications made within the scope and spirit equivalent to those of the appended claims.

### REFERENCE SIGNS LIST

1, 91 laminate, 10 lithium secondary battery, 11a, 11b, 911a, 911b insulating layer, 12, 912 positive electrode layer, 16, 916 negative electrode layer, 14 positive electrode collector, 18 negative electrode collector, 20, 920 separator, 22 electrolytic solution, 24 exterior body, 24a positive electrode can, 24b negative electrode can, 24c gasket, 111a, 111b insulating layer green sheet, 112 positive electrode green sheet, 116 negative electrode green sheet, 120 separator green sheet.

1. A lithium secondary battery, comprising a laminate, which includes a plurality of positive electrode layers, a plurality of negative electrode layers, and a plurality of separators, and in which the positive electrode layers and the negative electrode layers are alternately laminated through the separators,
wherein the laminate includes a first insulating layer and a second insulating layer,
wherein the first insulating layer is arranged in a first end portion of each of the positive electrode layers in a width direction thereof so as to be brought into contact with the positive electrode layer,
wherein the second insulating layer is arranged in a second end portion of each of the negative electrode layers in a width direction thereof, the second end portion being positioned on a side opposite to the first end portion in the width direction, so as to be brought into contact with the negative electrode layer, and
wherein when an external width of the laminate is represented by W, and an average of widths of the first insulating layers and widths of the second insulating layers is represented by wₐᵥₑ, a ratio “(wₐᵥₑ/W)×100” falls within a range of from 0.8 (%) to 40 (%).

2. The lithium secondary battery according to claim 1, wherein in the lithium secondary battery, when an average of absolute values of differences between the respective widths of the first insulating layers and the second insulating layers and the average wₐᵥₑ of the widths of the first insulating layers and the widths of the second insulating layers is defined as an average wₛ of variations in insulating layer width, (wₛ/wₐᵥₑ)×100≤20 (%) is satisfied.

3. The lithium secondary battery according to claim 1, wherein in the laminate, the positive electrode layers, the negative electrode layers, the separators, the first insulating layers, and the second insulating layers are an integrated sintered body that is integrally formed.

4. The lithium secondary battery according to claim 1,
wherein the lithium secondary battery further comprises:
an exterior body including a positive electrode can and a negative electrode can;
a first collector interposed between the positive electrode can and the positive electrode layers; and
a second collector interposed between the negative electrode can and the negative electrode layers,
wherein the first collector extends from a first side surface, which is on a side at which the positive electrode layers are exposed, out of side surfaces of the laminate, to a surface on a side closer to the positive electrode can out of an upper surface and a lower surface of the laminate, and
wherein the second collector extends from a second side surface, which is on a side at which the negative electrode layers are exposed, out of the side surfaces of the laminate, to a surface on a side closer to the negative electrode can out of the upper surface and the lower surface of the laminate.

5. The lithium secondary battery according to claim 1, wherein in the lithium secondary battery, the negative electrode layers each include a collector layer arranged inside the negative electrode layer in a thickness direction thereof, and the positive electrode layers are each free of a collector layer arranged inside in a thickness direction thereof.
